(19) United States
(12) Patent Application Publication
(10) Pub. No.: US 2016/0080893 A1
(43) Pub. Date: Mar. 17, 2016

(54) PORTABLE TERMINAL, DATA TRANSMISSION METHOD AND DATA TRANSMISSION SYSTEM

(71) Applicant: Kabushiki Kaisha Toshiba, Tokyo (JP)

(72) Inventor: Tokuji Kano, Zushi Kanagawa (JP)

(21) Appl. No.: 14/639,446

(22) Filed: Mar. 5, 2015

(30) Foreign Application Priority Data
Sep. 12, 2014 (JP) 2014-186746

(51) Int. Cl. H04W 4/00

(52) U.S. Cl. CPC H04W 4/008; H04W 84/18

(57) ABSTRACT

According to an embodiment, a portable terminal includes: a proximity wireless communication section configured to transmit data to a display apparatus placed within a predetermined distance; a memory configured to store the data to be transmitted to the display apparatus; a data control section configured to control the data to be transmitted from the memory to the display apparatus via the proximity wireless communication section; a bus to which a central processing unit is connected; and a communication channel directly connecting the memory and the proximity wireless communication section and not connected with the bus.

### CROSS-REFERENCE TO RELATED APPLICATION

This application is based upon and claims the benefit of priority from the Japanese Patent Application No. 2014-186746, filed on Sep. 12, 2014; the entire contents of which are incorporated herein by reference.

### FIELD

An embodiment described herein relates generally to a portable terminal, a data transmission method and a data transmission system.

### BACKGROUND

Recently, portable terminals such as smartphones have been increasingly provided with higher functions and a larger capacity. Accompanying this, services for distributing various kinds of motion pictures such as television and videos for portable terminals have been improved. Therefore, the number of people is increasing who download a desired drama, movie or the like to a portable terminal during a spare time period to appreciate it during a desired time period and at a desired place.

A portable terminal has an advantage that it is possible to enjoy a motion picture during a desired time period and at a desired place. On the other hand, since a size of a screen is smaller in comparison with a monitor of a television and a personal computer, there are disadvantages such as that it is only possible to appreciate a motion picture individually, that it is difficult to see details, and that realistic ambience is not obtained. Accordingly, conventionally, a method has been generally used in which a portable terminal and a large-screen monitor are connected via a cable, and a motion picture to be appreciated is transmitted from the portable terminal to the monitor to display the motion picture.

In the method described above, however, there is a problem that it is necessary to connect the portable terminal and the monitor via a dedicated cable each time a motion picture is to be transmitted, which is troublesome. If both of the portable terminal and the monitor have a wireless communication function, a method of wirelessly transmitting a motion picture using WLAN or Bluetooth(R) is also conceivable. In the case of wireless communication, however, there are a problem that much transfer time is required because a data transfer rate is slow, and a problem that a communication state may be unstable or communication quality may deteriorate because of an influence by an apparatus existing near a wireless communication channel.

### BRIEF DESCRIPTION OF THE DRAWINGS

FIG. 1 is a schematic block diagram illustrating a configuration of a portable terminal I according an embodiment of the present invention;

FIG. 2 is a diagram illustrating an example of configurations of files stored in a storage 22;

FIG. 3 is a schematic block diagram illustrating an example of a configuration of a switching network 12; and

FIG. 4 is a sequence diagram illustrating a procedure for transmitting data from the portable terminal 1 to a monitor 101.

### DETAILED DESCRIPTION

A portable terminal of an embodiment includes: a proximity wireless communication section configured to transmit data to a display apparatus placed within a predetermined distance; a memory configured to store the data to be transmitted to the display apparatus; a data control section configured to control the data to be transmitted from the memory to the display apparatus via the proximity wireless communication section; a bus to which a central processing unit is connected; and a communication channel connecting the memory and the proximity wireless communication section and not connected with the bus.

### Embodiment

An embodiment will be described below with reference to drawings.

### Configuration

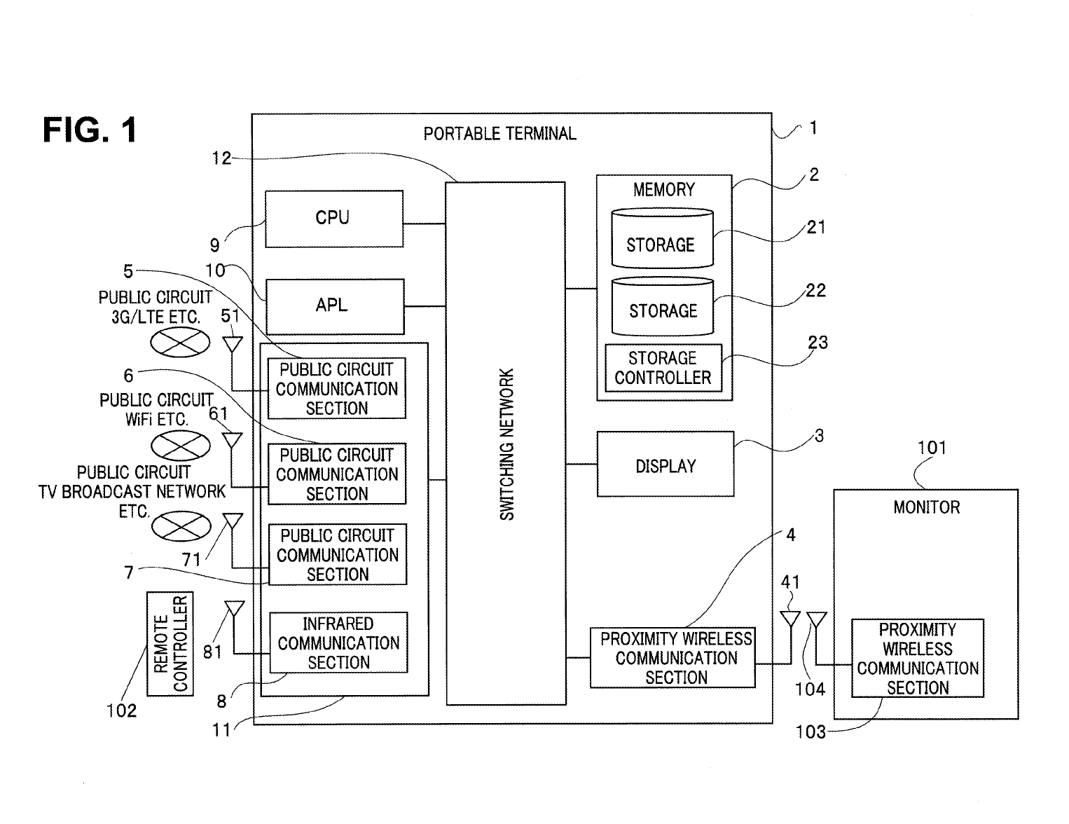

FIG. 1 is a schematic block diagram illustrating a configuration of a portable terminal 1 according an embodiment of the present invention. As shown in FIG. 1, the portable terminal 1 of the present embodiment has a memory 2 configured to store various kinds of data including image data; a display 3 as a display device, and a proximity wireless communication section 4 configured to perform proximity wireless communication with an external monitor 101 and the like. The portable terminal 1 also has a central processing unit (hereinafter referred to as a CPU) 9, an application (hereinafter referred to as an APL) 10 configured to cause a predetermined function to be executed, a communication I/F 11 configured to perform wireless communication with an external network and the like.

When the portable terminal 1 is arranged within a predetermined distance from the monitor 101 having a proximity wireless communication function, the proximity wireless communication section 4 establishes wireless connection with the monitor 101 and performs data transmission/reception. The communication between the portable terminal 1 and the monitor 101 is performed, for example, by proximity wireless communication in a peer-to-peer form using TransferJet™. TransferJet™ is a proximity wireless communication system using ultra-wideband radio (UWB), and it makes it possible to perform data transfer at a higher speed in comparison with wireless communication in which voice and data (packet) communication is performed via a base station of a carrier, such as 3G or LTE wireless communication, and wireless communication in which data communication is performed via a wireless LAN router, such as a WiFi router.

A proximity wireless communication antenna 41 is connected to the proximity wireless communication section 4. The proximity wireless communication antenna 41 is not a conventional-type antenna using a radiation field but is configured with coupler elements using an induction field. When a distance between the proximity wireless communication antenna 41 of the portable terminal 1 and a proximity wireless communication antenna 104 of the monitor 101, which is a terminal to perform communicate with, is close to a communicable distance (for example, about 3 cm) or less, both of the antennas 41 and 104 are coupled by electromagnetic induction. Thereby, wireless communication between the portable terminal 1 and the monitor 101 becomes executable.

The communication I/F 11 has a public circuit communication section 5 configured to perform wireless communication using a public circuit, for example, a 3G or LTE public circuit, and a public circuit communication section 6 configured to perform wireless communication using a wireless LAN such as a WiFi LAN. Wireless communication antennas 51 and 61 are connected to the public circuit communication sections 5 and 6, respectively. Each of the wireless communication antennas 51 and 61 is configured with a conventional-type antenna using a radiation electromagnetic field. The communication I/F 11 also has a public circuit communication section 7 configured to receive TV broadcast using a public circuit such as a TV broadcast network. A TV antenna 71 is connected to the public circuit communication section 7.

Furthermore, the communication I/F 11 also has an infrared communication section 8 configured to perform proximity wireless communication with a terminal (for example, a remote controller 102) mounted with another IrDA (infrared data association)-system infrared communication section, using an IrDA system. A communication distance between terminals is 1 m according to the IrDA DATA standard. A wireless communication antenna 81 is connected to the infrared communication section 8, and the terminals performing infrared communication perform the communication such that infrared communication ports not shown face with each other without an obstacle therebetween.

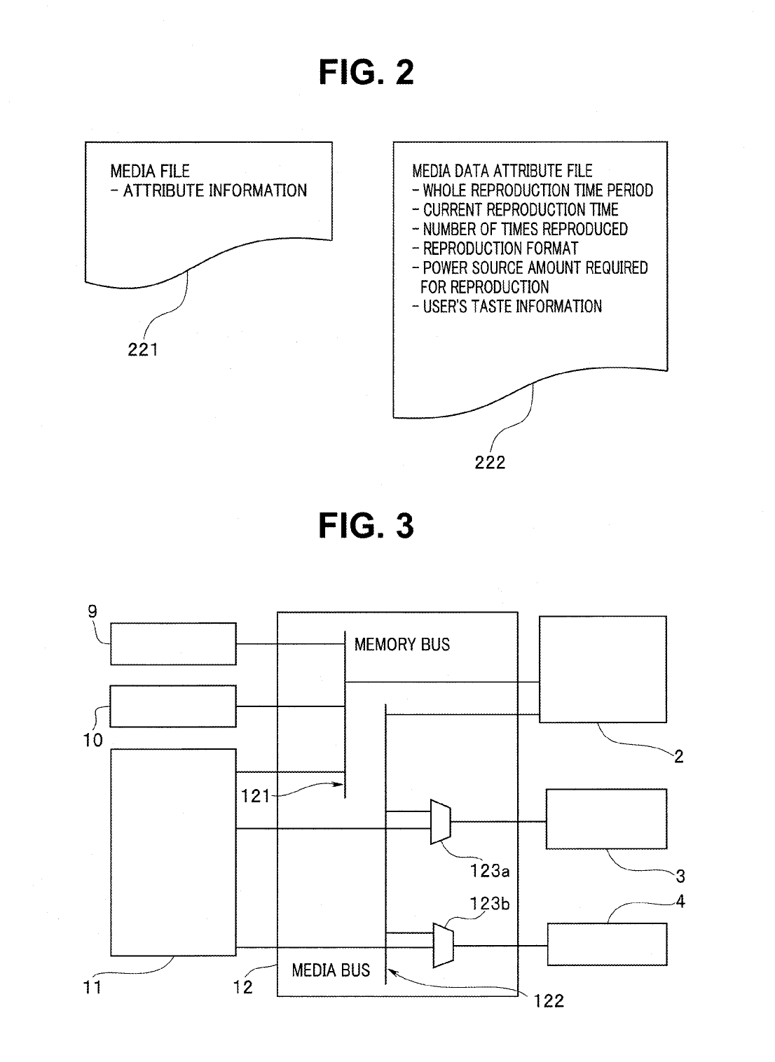

The memory 2 is configured with a storage 21 used to store data which is generally used by the portable terminal 1, such as various kinds of applications and data related to an operation system, a storage 22 used to store media data, and a storage controller 23 as a data control section configured to control input/output of data of the storage 22. In the storage 22, a media file 221 in which media data itself, such as an image and voice, is written, and a media data attribute file 222 in which various kinds of information accompanying the media data written in the media file 221 (hereinafter referred to as an attribute file 222) are stored as shown in FIG. 2. FIG. 2 is a diagram illustrating an example of configurations of the files stored in the storage 22.

In the attribute file 222, pieces of information, for example, a whole reproduction time period, current reproduction time, the number of times reproduced, a reproduction format, a power source amount required for reproduction, restriction information (such as the possible number of times of copying and an appreciation period) and user's taste information are written for each media file.

The memory 2, the display 3, the proximity wireless communication section 4, the CPU 9, the APL 10 and the communication I/F 11 are connected to a switching network 12. The switching network 12 is a communication network for performing communication of data between connected sections, and the switching network 12 has, for example. two buses of a memory bus 121 and a media bus 122 as a communication channel, as shown in FIG. 3. FIG. 3 is a schematic block diagram illustrating an example of a configuration of the switching network 12.

The memory bus 121 is a bus mainly for performing writing and reading of data to and from the memory 2, from another unit; and the memory 2, the CPU 9, the APL 10 and the communication I/F 11 are connected thereto. The media bus 122 is a bus mainly for outputting media data to the display device and controlling media data; and the memory 2, the display 3 and the proximity wireless communication section 4 are connected thereto.

Note that the display 3 and the proximity wireless communication section 4 are connected to the media bus 122 via multiplexers 123a and 123b, respectively, the multiplexers serving as a switch section. The media bus 122 and the communication FF 11 are connected to input sides of the two multiplexers 123a and 123b. Thus, any of media data stored in the memory 2 and media data inputted from an external public line, TV broadcast or the like via the communication I/F 11 can be selected and outputted to the display 3 and the monitor 101.

For example, in a case of transmitting media data stored in the memory 2 from the proximity wireless communication section 4 to the monitor 101. desired data is read from the memory 2 and outputted to the proximity wireless communication section 4 via the media bus 122 and the multiplexer. Note that management and operation of media data stored in the memory 2 is performed by the storage controller 23.

By using not only a conventional-type bus but also the media bus 122 which is not connected to the CPU 9 for connection of each section constituting the portable terminal 1 as described above, it is possible to smoothly transmit even a large amount of media data to the monitor 101 and the like without data communication being delayed in the neck of the CPU 9

Note that the configuration of the switching network 12 is not limited to the configuration in which two buses are arranged as shown in FIG. 3. The switching network 12 may be configured with three or more buses. Further, the configuration may include a configuration such that the communication channel is dynamically constructed on demand.

### Operation

Next, an operation of the portable terminal 1 in the present embodiment will be described. More specifically, description will be made on a case of transmitting media data stored in the memory 2 of the portable terminal 1 to the monitor 101 and reproducing the media data.

Note that media data is downloaded from a public circuit such as a 3G and LTE public circuit or a wireless LAN such as a WiFi LAN, TV broad cast or the like and stored into the media file 221 of the memory 2 via the communication I/F 11. Note that the memory 2 is not limited to a built-in memory, and a memory card or the like is also possible. At time of downloading media data and storing the media data into the media file 221, attribute information for reproduction is added. In the attribute file 222, pieces of information such as a whole reproduction time period, current reproduction time, the number of times reproduced, a reproduction format, a power source amount required for reproduction, restriction information (such as the possible number of times of copying and an appreciation period) and user's taste information, which are concrete attribute information, are written for each media file.

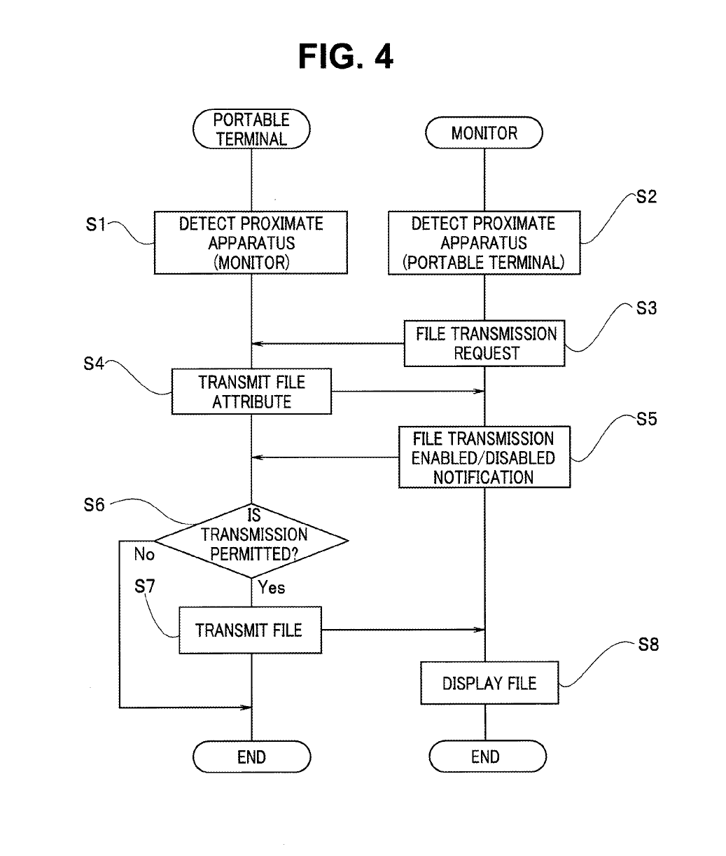

A procedure for transmitting the media data stored into the memory 2 as described above, to the monitor 101 and reproducing the media data will be described with the use of FIG. 4. FIG. 4 is a sequence diagram illustrating a procedure for transmitting data from the portable terminal 1 to the monitor 101.

First, the portable terminal 1 is placed at a position within a predetermine distance from the monitor 101. Thereby, the proximity wireless communication antenna 41 of the portable terminal 1 and the proximity wireless communication antenna 104 of the monitor 101 are coupled by electromagnetic induction, and high-speed proximity wireless communication becomes executable between the portable terminal 1 and the monitor 101. That is, the portable terminal 1 detects the monitor 101 as an apparatus capable of performing proximity wireless communication (step S1), and the monitor 101 detects the portable terminal 1 as an apparatus capable of performing proximity wireless communication (step S2). At each step below, data transmission/reception between the portable terminal 1 and the monitor 101 is performed with use of proximity wireless communication.

Next, a request to transmit a particular media file is sent from the monitor 101 to the portable terminal 1 (step S3). The request from the monitor 101 to transmit the media file is transmitted from the proximity wireless communication section 4 to the memory 2 via the media bus 122. Note that it is assumed that each of the monitor 101 and the portable terminal 1 is mounted with, for example, a predetermined file management application, and that the monitor 101 has file information about media data stored in the portable terminal 1. When the monitor 101 does not have the file information about the media data stored in the portable terminal 1, it is necessary to acquire the file information from the portable terminal 1 before executing step S3.

Then, the procedure proceeds to step S4, and the portable terminal 1 transmits attribute information about the specified media file to the monitor 101. More specifically, the storage controller 23 of the memory 2 extracts the attribute file 222 in which the attribute information about the media file specified in the media file request received at step S3. Then, contents of the file are transmitted to the monitor 101 via the media bus 122 and the proximity wireless communication section 4.

In general, since attribute information for reproduction of media data is managed on application software of the portable terminal 1, it is not possible to transmit the media data to an external apparatus or reproduce the media data unless a function on a portable terminal 1 side or a processing capability of the CPU 9 is used. However, according to the present embodiment, since the attribute information for reproduction is stored in the memory 2 as the attribute file 222, and the storage controller 23 for performing management and operation of media data is provided, it is possible to easily transmit attribute information and media data in response to a request from the monitor 101 or the like which is proximally and wirelessly connected.

The monitor 101 refers to the attribute information received from the portable terminal 1, judges whether the specified media file can be displayed on the monitor 101 and notifies the portable terminal 1 of a result (step S5). For example, if a reproduction format of the file written in the attribute information is a format which cannot be displayed on the monitor 101, the monitor 101 transmits a notification to the effect that the file cannot be transmitted, to the portable terminal 1.

If transmission is permitted in the file transmission enabled/disabled notification transmitted from the monitor 101 (step S6: Yes), the portable terminal 1 transmits the file of the media data specified at step S3 to the monitor 101 (step S7). More specifically, the storage controller 23 of the memory 2 extracts the media file 221 specified in the media file request received at step S3. Then, contents of the file are transmitted to the monitor 101 via the media bus 122 and the proximity wireless communication section 4.

On the other hand, if it is notified in the file enabled/disabled notification that transmission is not possible (step S6: No), a series of processes on the portable terminal 1 side ends without transmitting the media data. If the media data is not transmitted even after a predetermined time period elapses, the monitor 101 judges time-out and ends a series of processes.

When receiving the file of the media data from the portable terminal 1, the monitor 101 displays the file (step S8). At this time, control for reproduction, stop, fast-forward, rewind and the like of the media file to be displayed on the monitor 101 may be performed by the remote controller 102 attached to the monitor 101. For example, information about the remote controller 102 attached to the monitor 101 is registered with the portable terminal 1 in advance. If a notification to the effect that operation by the remote controller 102 is enabled is made from the storage controller 23 to the CPU 9, an operation signal (an infrared signal) of the remote controller 102 received from the antenna 81 is transmitted to the storage controller 23 via the infrared communication section 8 and the switching network 12. The storage controller 23 controls media data to be transmitted to the monitor 101 in accordance with the inputted operation signal. Display of a media file transmitted to the monitor 101 ends, the series of processes of both of the portable terminal 1 and the monitor 101 end.

As described above, according to the present embodiment, such proximity wireless communication is used that is enabled only when the portable terminal 1 and the monitor 101 are placed at an extremely short distance of several centimeters or less from each other, it is possible to maintain a stable communication state and communication quality without an influence by an apparatus existing near a wireless communication channel. Furthermore, since the storage controller 23 specialized in management and operation of media data, and the media bus 122 through which media data can be transmitted from the memory 2 to the proximity wireless communication section 4 without an influence by the other sections of the portable terminal 1, such as the CPU 9, are provided, it is possible to transfer the media data at a high speed irrespective of an operation situation of other functions of the portable terminal 1 and without having an influence on background communication of a public circuit such as a 3G or LTE public circuit and a wireless LAN such as a WiFi LAN.

Note that, though the portable terminal 1 of the present embodiment can perform transmission of media data without influencing other functions or being influenced by other functions mounted on the portable terminal 1, such as a telephone call function, as described above, it is also possible to restrict the other functions during transmission of media data. For example, by notifying the CPU 9 from the storage controller 23 that transmission of media data is to be started, before transmitting a media file from the portable terminal 1 to the monitor 101 at step S7 in FIG. 4, the CPU 9 may control the other sections of the portable terminal 1 to restrict operations of other applications.

Each “section” in the present specification is conceptually corresponds to each function of the embodiment and does not necessarily correspond to particular hardware or a software routine one-to-one. Therefore, in the present specification, the embodiment has been described on an assumption of a virtual circuit block (section) having each function of the embodiment.

While certain embodiments have been described, these embodiments have been presented by way of example only, and are not intended to limit the scope of the inventions. Indeed, the novel methods and devices described herein may be embodied in a variety of other forms; furthermore, various omissions, substitutions and changes in the form of the methods and devices described herein may be made without departing from the spirit of the inventions. The accompanying claims and their equivalents are intended to cover such forms or modifications as would fall within the scope and spirit of the inventions.

What is claimed is:

1. A portable terminal comprising:
a proximity wireless communication section configured to transmit data to a display apparatus placed within a predetermined distance;
a memory configured to store the data to be transmitted to the display apparatus;
a data control section configured to control the data to be transmitted from the memory to the display apparatus via the proximity wireless communication section;
a bus to which a central processing unit is connected; and
a communication channel connecting the memory and the proximity wireless communication section and not connected with the bus.

2. The portable terminal according to claim 1, wherein the communication channel is provided with a switch section.

3. The portable terminal according to claim 1, wherein
the data is media data; and
the memory comprises a first storage configured to store only the media data and a second storage configured to store other data.

4. The portable terminal according to claim 1, wherein, in response to a request from the display apparatus to transmit the data, the data control section transmits the data requested to be transmitted, from the memory to the display apparatus via the communication channel and the proximity wireless communication section.

5. The portable terminal according to claim 1, wherein execution of a function other than transmission of the data is restricted while the data is transmitted from the memory to the display apparatus.

6. The portable terminal according to claim 2, wherein
the data is media data; and
the memory comprises a first storage configured to store only the media data and a second storage configured to store other data.

7. The portable terminal according to claim 6, wherein in response to a request from the display apparatus to transmit the data, the data control section transmits the data requested to be transmitted, from the memory to the display apparatus via the communication channel and the proximity wireless communication section.

8. The portable terminal according to claim 7, wherein execution of a function other than transmission of the data is restricted while the data is transmitted from the memory to the display apparatus.

9. A data transmission method comprising:
receiving a request from a display apparatus to transmit a particular file placed within a predetermined range from a portable terminal;
extracting the particular file from a memory;
constructing a communication channel independent of a bus and connecting the memory and a proximity wireless communication section; and
transmitting the data from the memory to the display apparatus via the communication channel and the proximity wireless communication section.

10. The data transmission method according to claim 9, wherein the central processing unit is provided with a switch section.

11. The data transmission method according to claim 10, wherein
the data is media data; and
the memory comprises a first storage configured to store only the media data and a second storage configured to store other data.

12. The data transmission method according to claim 11, wherein a data control section configured to control output of the media data from the first storage is provided.

13. A data transmission system comprising:
a display apparatus configured to display media data; and
a portable terminal having the media data; wherein
the portable terminal comprises:
a proximity wireless communication section configured to transmit the media data to the display apparatus placed within a predetermined distance;
a memory configured to store the media data to be transmitted to the display apparatus;
a data control section configured to control the media data to be transmitted from the memory to the display apparatus via the proximity wireless communication section;
a bus to which a central processing unit is connected; and
a communication channel connecting the memory and the proximity wireless communication section and not connected with the bus.

14. The data transmission system according to claim 13, wherein the communication channel is provided with a switch section.

15. The data transmission system according to claim 14, wherein, in response to a request from the display apparatus to transmit the media data, the data control section constructs the communication channel and transmits the media data from the memory to the display apparatus via the communication channel and the proximity wireless communication section.

16. The data transmission system according to claim 15, wherein
the display apparatus further comprises a remote controller configured to control display of the media data; and
when the portable terminal receives a control signal of the media data outputted from the remote controller, the data control section controls transmission of the media data in accordance with the control signal.
